(19) United States
(12) Patent Application Publication
(10) Pub. No.: US 2004/0225508 A1
(43) Pub. Date: Nov. 11, 2004

(54) Reusable canonical e-business process

(76) Inventor: Prem S. Urali, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/429,299

(22) Filed: May 5, 2003

(51) Int. Cl. G06F 17/60

(52) U.S. Cl. 705/1

(57) ABSTRACT

A system and method to facilitate a reusable canonical e-business process is provided. A two-layer approach is employed. With regard to incoming information, a first level includes one or more external interfaces which transform information received (e.g., from an external trading partner) into an internal standard format. The internal standard format is then used by a second level internal interface to facilitate an internal business process. Similarly, for outgoing information, information is first processed by an internal standard interface and then transformed from an internal standard format into external standard format(s) by appropriate external standard interface(s).

### TECHNICAL FIELD

The present invention generally relates to e-business processing, and in particular to systems and methods to facilitate a reusable canonical e-business process.

### BACKGROUND OF THE INVENTION

Electronic commerce (e.g., e-commerce and e-business) has revolutionalized business practices by providing an efficient, reliable and cost-effective medium for business transactions. The revolution has fueled a growing trend towards eliminating paper transactions and conducting a large volume of business electronically. Many businesses have already shifted paradigms and are conducting a substantial portion of their business via networks (e.g., the Internet, virtual private networks and/or an intranets).

One advantage of conducting e-business is that it provides a business with the capability to efficiently transmit and receive information from essentially anywhere and at any time. The impact of such accessibility has provided business relationships with markets that were once unavailable, world-wide visibility, increased competition within markets, quality improvements, “true” market driven prices, increased buyer/seller choice, decreased operational costs through mitigating overhead such as paper products, and diminished paper waste.

The robustness of e-business continues to progress with technological advances in the electrical/electronics and software fields. Such advances provide improved communication devices and improved user-friendly applications. In addition, the availability and affordability of computerized systems and e-business software that can be executed thereon facilitates the growing trend towards selling and purchasing goods via e-business. From the foregoing advances and trends, it has become foreseeable that the near future will demand business transactions to be conducted via e-business in order to compete within a business market.

A simple example of an e-business transaction includes a business-to-business purchase of goods. For example, a seller and a buyer can interface via a network (e.g., the Internet), wherein the seller can provide product information, including price. The buyer can submit an order to the seller for a quantity of goods as an e-business transaction. For example, the buyer can submit a purchase order via an e-business transaction instead of the conventional means of mailing a paper form. When the seller receives the e-business purchase order, the seller can process the order and reply with an e-business invoice.

Information can be transmitted between parties to an e-business transaction in one or more standard format(s), for example, RosettaNet, cXML, xCBL, EDI (4010, 4020) and/or SWIFT. Additionally, the standard(s) can have various version(s) and/or revision level(s). Thus, a particular party to e-business transactions may need to be able to communicate in a plurality of standard formats. For example a manufacturer desiring to participate in a RosettaNet standard transaction with a trading partner might at the same time be inclined to participate in a cXML transaction with another trading partner.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides systems and methods to facilitate a reusable canonical e-business process. A two-layer approach is employed. With regard to incoming information, an external standard(s) layer includes one or more external interfaces which transform information received (e.g., from an external trading partner) into an internal standard format. The internal standard format is then used by an internal standard layer to facilitate an internal business process(es). Similarly, for outgoing information, information is first processed by an internal standard layer and then transformed to external standard format(s) by an external standard(s) layer.

By implementing the two-layer design, external compliance and a single executable for managing the internal business process are accomplished. The present invention thus mitigates potential problem(s) associated with multiple external standard(s) and/or multiple standard(s) having multiple revisions (e.g., fulfilling the need for maintaining multiple external standards in order to communicate with multiple types of trading partners). Further, standardization of internal business process(es) into a single executable business process (e.g., built to handle a specific business scenario) is also accomplished. Thus, the present invention facilitates ease of maintenance of internal processes independent of the evolution and/or development of external standard format(s).

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of an e-business system in accordance with an aspect of the present invention.

FIG. 2 is a block diagram of an e-business system in accordance with an aspect of the present invention.

FIG. 3 is a block diagram of an e-business system in accordance with an aspect of the present invention.

FIG. 4 is a block diagram of an e-business system in accordance with an aspect of the present invention.

FIG. 5 is a flow chart of a method of facilitating e-business in accordance with an aspect of the present invention.

FIG. 6 is a flow chart of a method of facilitating e-business in accordance with an aspect of the present invention.

FIG. 7 is a flow chart of a method of facilitating e-business in accordance with an aspect of the present invention.

FIG. 8 illustrates an example operating environment in which the present invention may function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the term “computer component” is intended to refer to a computer-related entity, either hardware, a combination of hardware and software, software, or software in execution. For example, a computer component may be, but is not limited to being, a process running on a processor, a processor, an object, an executable, a thread of execution, a program, and/or a computer. By way of illustration, both an application running on a server and the server can be a computer component. One or more computer components may reside within a process and/or thread of execution and a component may be localized on one computer and/or distributed between two or more computers.

The novel architecture of the present invention is an innovative approach to solving problem(s) associated with maintaining internal business rule(s) while participating in one or more external standard(s). The external standards may be de jure (e.g., mandated by a consortium) and/or de facto (e.g., happenstance). By separating processing of external standard(s) and internal business rule(s), the architecture of the present invention facilitates extensibility and adaptability to the ever-changing e-business environment.

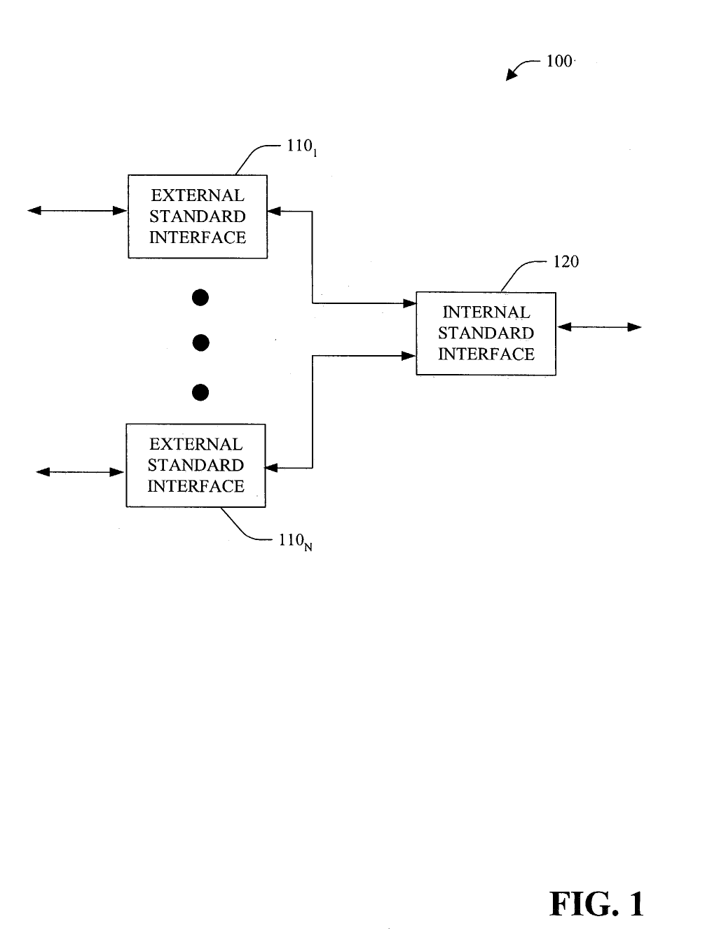

Referring to FIG. 1, an e-business system 100 in accordance with an aspect of the present invention is illustrated. The system 100 receives an input (e.g., business document) in an external standard format. The input is transformed from the external standard format into an internal standard by external standard interface(s) 110. Thereafter the internal standard is transformed into a business process format by an internal standard interface 120. The system 100 thus facilitates extensibility to ever-changing external standards. As external standards are created and/or modified, associated external standard interface(s) 110 are likewise created and/or modified, as appropriate. Further, business process rule(s) are compartmentalized via the internal standard interface 120. Thus, when changes to business process rule(s) are made, the internal standard interface 120 is correspondingly modified (e.g. the external standard interface(s) 110 are not modified).

The system 100 includes a first external standard interface 110₁ through an Nth external standard interface 110_{N}, N being an integer greater than or equal to one. The first external standard interface 110₁ through the Nth external standard interface 110_{N} can be referred to collectively as the external standard interface(s) 110. The external standard interface(s) 110 implement external business process(es). For example, external business processes can be determined by way of either a formal agreement between several interacting parties (e.g., a consortium) and/or by way of informal arrangements between trading partners (e.g., documentation of historical trial and error). Formal external standards can go through an elaborate standardization process (e.g., several months to years). Examples of external standards include, but are not limited to, RosettaNet, cXML, xCBL, EDI (4010, 4020) and/or SWIFT. Additionally, external standards can undergo revision(s), thus, for example, a trading partner can be engaged in commerce with a first trading partner with a particular revision to an external standard and concurrently engaged in commerce with a second trading partner with a different revision to the same external standard (e.g., not all of the trading partners have caught up to the current version and/or a common version of the external standard).

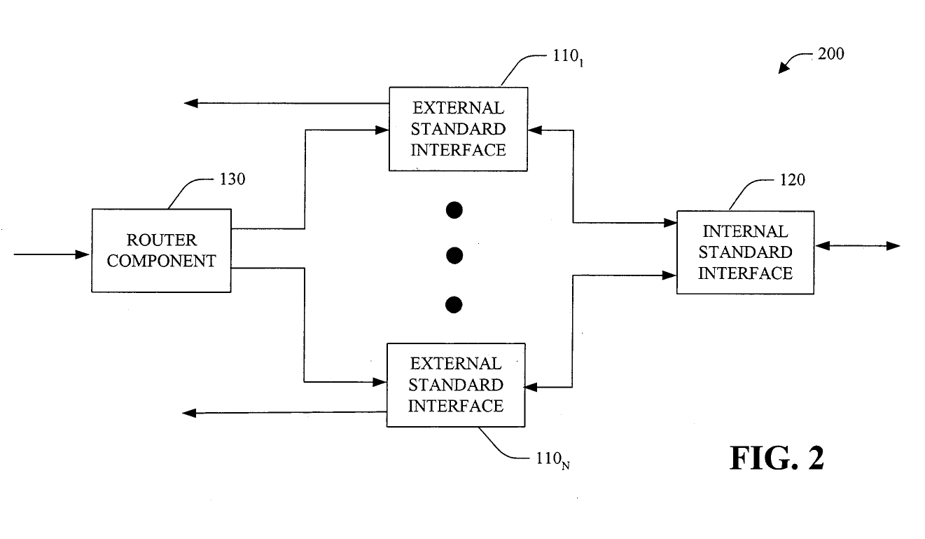

Accordingly, the system 100 mitigates potential problem(s) associated with multiple external standard(s) and/or multiple standard(s) having multiple revisions. Thus, in one example, an external standard interface 110 can be instantiated for each external standard and/or revision of an external standard for which a trading partner expects to receive input (e.g., business document(s)). In another example, referring briefly to FIG. 2, a router component 130 instantiates an external standard interface 110 associated with a particular external standard and/or revision of an external standard based, at least in part, upon information associated with an input. The router component 130 can review the input and determine explicitly (e.g., self-described business document) and/or implicitly which associated external standard interface 110 to instantiate and receive the input.

Turning back to FIG. 1, the internal standard interface 120 implements, for example, internal business process(es). Internal business process(es) are typically well-defined and/or static (e.g., not modified unless a business process re-engineering is implemented). They can involve several interrelated processes and can be very complex (e.g., a change to one aspect can affect other aspect(s) of the business process). For example, if a company desires to implement internal business processes associated with processing of returns of merchandise sold online at one of its stores, merchandise exchange(s) also should be accounted for by the internal business processes.

In one example, the external standard interface(s) 110 receives business item(s) in an external standard format, transforms the business item(s) into an internal standard format and provides the transformed business item(s) to the internal standard interface 120. In another example, the internal standard interface receives business item(s) in an internal standard format, implements business logic upon the business item(s) and provides the business item(s) to the external standard interface. In yet a third example, the external standard interface(s) 110 and the internal standard interface 120 are bi-directional.

For example, the internal standard interface 120 can be versioned such that incrementally new external standards can be supported by way of augmenting and/or adding functionality to the internal business process implementations.

The system 100 thus implements a two-layer design that addresses the needs of external compliance and the need for having a single executable for managing the internal business process. The system 100 thus fulfills the need for maintaining multiple external standards in order to communicate with multiple types of trading partners. The system further facilitates standardization of internal business processes into a single executable business process (e.g., built to handle a specific business scenario). The system 100 thus facilitates ease of maintenance of internal processes independent of the evolution and/or development of the external standards.

While FIG. 1 is a block diagram illustrating components for the system 100, it is to be appreciated that the system 100, the external standard interface(s) 110, the internal standard interface 120 and/or the router component 130 can be implemented as one or more computer components, as that term is defined herein. Thus, it is to be appreciated that computer executable components operable to implement the system 100, the external standard interface(s) 110, the internal standard interface 120 and/or the router component 130 can be stored on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the present invention.

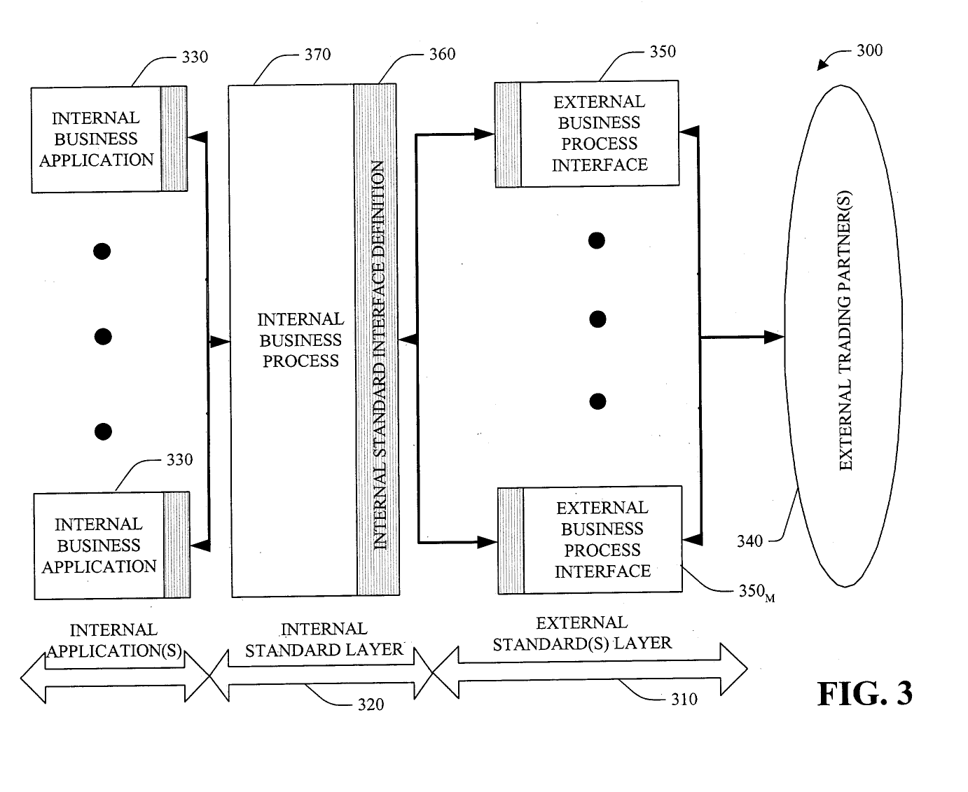

Turning to FIG. 3, an e-business system 300 in accordance with an aspect of the present invention is illustrated. The system 300 implements a two-layer architecture that addresses compliance with external standard(s) and provides a single executable for managing internal business process(es).

In one example, the system 300 receives business document(s) from external trading partner(s) 340. The business document(s) are first processed by an external standards layer 310 which transforms the business document(s) into an internal standard format. Thereafter, the transformed business document(s) are processed by an internal standard layer 320 and provided to one or more internal business application(s) 330.

In another example, the system 300 sends business document(s) to external trading partners 340. One or more internal business application(s) 330 generate business document(s) in an internal standard format. The business document(s) are processed by the internal standard layer 320. The business document(s) are then transformed from the internal standard format into one or more external standards by the external standards layer 310. The transformed business document(s) are then provided to the external trading partner(s) 340.

The external standards layer 310 can include a first external standard interface 350, through an Mth external standard interface 350_{M}, M being an integer greater than or equal to one. The first external standard interface 350₁ through the Mth external standard interface 350_{M} M can be referred to collectively as the external standard interface(s) 350.

The external standard interface(s) 350 implement external business process(es) (e.g., by formal agreement and/or informal arrangements). As discussed supra, external standards can undergo revision(s). The system 300 mitigates potential problem(s) associated with multiple external standard(s) and/or multiple standard(s) having multiple revisions, for example, an external standard interface 350 can be instantiated for each external standard and/or revision of an external standard for which a trading partner expects to receive input. The external standard interface(s) 350 can be instantiated based upon e-business processing expectations and/or dynamically instantiated based, at least in part, upon input received (e.g., via a router component (not shown))

The internal standard layer 320 can include an internal standard interface definition 360 and an internal business process 370. The internal standard interface definition 360 defines the internal business process 370. Generally, the internal business process 370 is well-defined and/or static (e.g., not modified unless a business process re-engineering is implemented). The internal business process 370 can involve several interrelated processes and can be very complex (e.g., a change to one aspect can affect other aspect(s) of the business process).

Internal business processing rule(s) can be defined in the internal standard interface definition 360. For example, a business can identity processing of received purchase orders of greater than ten thousand dollars as a high priority item. The internal standard interface definition 360 can include an associated definition indicating that purchase order(s) of greater than ten thousand dollars are to be processed before purchase order(s) of less than or equal to ten thousand dollars. The definition can be utilized by the internal business process 370 when performing processing. The internal business process 370 then provides the processed received input (e.g., in an internal standard format) to one or more internal business application(s) 330.

In one example, the external business process interface(s) 350 and the internal standard layer 320 communicate via a strongly typed interface. This interface defines the protocol to be complied (e.g., request-response, timeout, lower layer protocol such as SOAP, DCOM, HTTP Post etc.) and/or data element(s) of the information (e.g., business document(s)) to be exchanged (e.g., via XSD document definition(s)).

It is to be appreciated that the system 300, the external standards layer 310, the internal standards layer 320, the internal business application(s) 330, external business process(es) 350, internal standard interface definition 360 and/or internal business process 370 can be computer components as that term is defined herein.

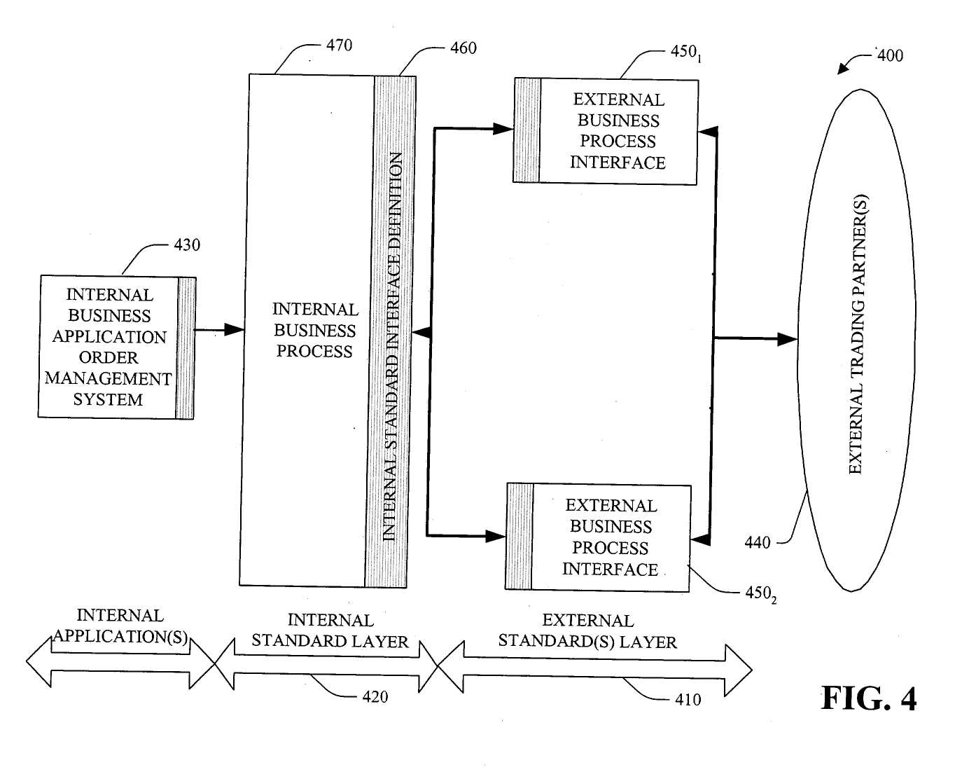

Next, referring to FIG. 4, an e-business system 400 in accordance with an aspect of the present invention is illustrated. The system 400 implements a two-layer architecture that addresses compliance with external standard(s) and provides a single executable for managing internal business process(es). The system 400 includes an external standard(s) layer 410 and an internal standard layer 420.

For an outgoing transaction, the external standard(s) layer 410 transforms a document from an internal standards format into an external standards format (e.g., RosettaNet, cXML, xCBL, EDI (4010, 4020) and/or SWIFT). For an incoming transaction, the external standard(s) layer 410 transforms a document from an external standards format into the internal standards format. The external standard(s) layer 410 can receive document(s) from external trading partner(s) 440. The external standard(s) layer 410 can include one or more external business process interface(s) 450 that implement external business process(es) (e.g., by formal agreement and/or informal arrangements).

The internal standard layer 420 processes documents in an internal standards format, and, can include an internal standard interface 460 and an internal business process 470. The internal standard interface 460 defines an internal business process 470. Generally, the internal business process 470 is well-defined and/or static (e.g., not modified unless a business process re-engineering is implemented). The internal business process 470 can involve several interrelated processes and can be very complex (e.g., a change to one aspect can affect other aspect(s) of the business process).

For example, the system 400 can include a first external business process interface 450₁ which receives/sends cXML Version 1.2 documents from/to external trading partner(s) 440. The first external business process interface 450₁ implements the external business process(es) associated with cXML documents. For incoming transaction(s) (e.g., document(s) received from external trading partner(s) 440), the first external business process interface 450₁ transforms the document(s) into an internal standard format and provides the transformed document to the internal standard layer 420. For out going transaction(s) (e.g., document(s) to be sent to external trading partner(s) 440), the first external business process interface 450₁ transforms document(s) received in the internal standard format into a cXML representation, and, provides the cXML representation to external trading partner(s) 440.

The exemplary system 400 further includes a second external business process 450₂ which receives/sends RosettaNet RNIF 2.0 documents from/to trading partner(s). The second external business process interface 4502 implements the external business process(es) associated with RosettaNet RNIF 2.0 documents.

Thus, the exemplary system 400 compartmentalizes implementation of multiple external business process standards—cXML in the first external business process interface 450₁ and RosettaNet in the second external business process interface 450₂. The exemplary system 400 further compartmentalizes implementation of internal business process(es) in the internal standard layer 420 (e.g., internal standard interface 460). As such, overhead associated with maintenance of business logic is reduced over conventional system(s) since only the internal standard interface 460 is modified. For example, logic to implement “manager approval of order(s) greater than ten thousand dollars” is only added to the internal standard interface 460—the first external business process interface 450₁ and the second external business process interface 450₂ do not have to be modified to implement this logic.

With respect to external business standard(s), user(s) of the exemplary system 400 can selectively implement functionality associated with the external business standard(s). For example, with regard to the cXML1.2 standard, the first external business process standard 450₁ can implement “ProfileRequest” and “ProfileResponse” message set. The profile transaction set is used to retrieve cXML server capabilities including the supported cXML version, transactions and/or options on those transactions. Additionally, the first external business process standard interface 450₁ can implement “OrderRequest” as an accepted document. The acceptance of this document requires a synchronous Response to be implemented. This Response document acknowledges the physical receipt of the document and not necessarily the ability to fulfill the request. It is to be appreciated that cXML does not have a concept of an order acceptance, generated after the physical goods (or whatever has been ordered, in the case of nonphysical goods) have been reserved.

Further, with regard to RosettaNet 2.0, the second external business process interface 450₂ can implement the 0A1 PIP (Partner Interface Processes) which serves the purpose of notifying an error in processing by either of the two communicating parties involved in the interface activity. For example: a) The originating party of the business activity times-out when waiting for a specified response for their requesting business document; and/or, b) the responding party is unable to acknowledge, accept or process the requesting business document. The purchase order functionality is implemented as the 4A4 PIP specification in Rosettanet. The “Request Purchase Order” Partner Interface Process™ (PIP®) enables a customer to issue a purchase order, and for the system 400 to acknowledge, at the line level, if the order is accepted, rejected, or pending. The system 400's acknowledgment can also include related information about delivery expectations.

The exemplary system 400 can be implemented as a set of three orchestrations: external business process, interface definition and implementation of common business logic. The external business processes can be defined in individual orchestrations. Each orchestration needs only to worry about implementing the logic required to comply with that one standard. The interface between the two external standards layers (each implemented as an orchestration) and the internal business process orchestration is strongly defined. The document types accepted by the internal business process are well-defined. Also, the protocol expectations are also defined. This is all documented in the form of an interface specification published for the internal business process orchestration. Finally, the common business logic (e.g., in this case the need to track all orders over ten thousand dollars for manager approval) is implemented in the internal business process orchestration.

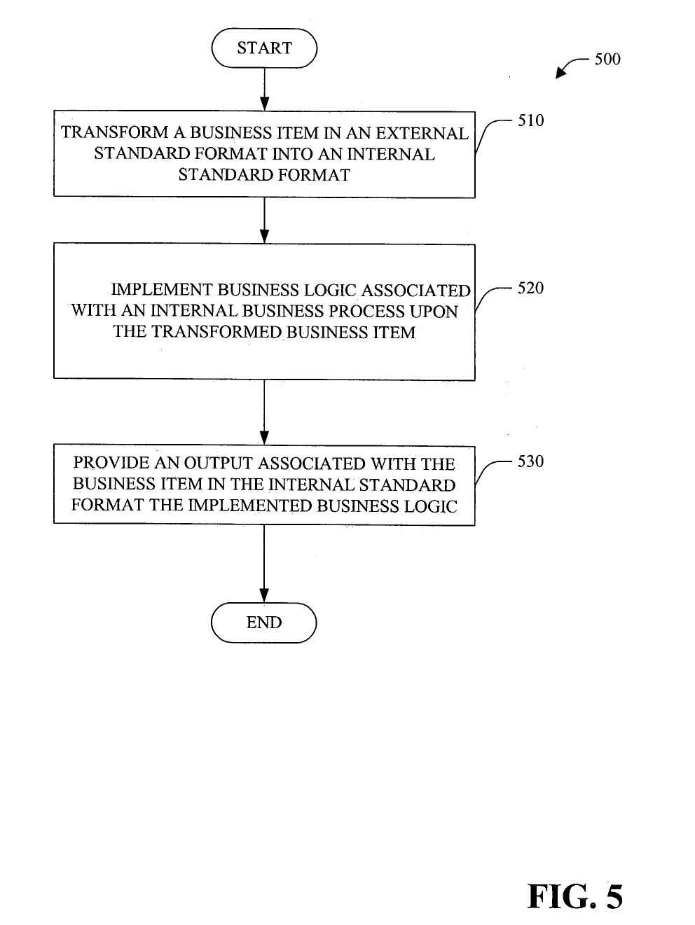

Turning briefly to FIGS. 5, 6 and 7, methodologies that may be implemented in accordance with the present invention are illustrated. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

The invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 5, a method of facilitating e-business 500 in accordance with an aspect of the present invention is illustrated. At 510, a business item (e.g., business document) is transformed from an external standard format (e.g., cXML, RosettaNet, xCBL, EDI 4010, EDI 4020 and/or SWIFT) into an internal standard format. At 520, business logic associated with internal business process(es) is implemented upon the transformed business item. At 530, an output associated with the business item in the internal standard format is provided (e.g., to internal business application(s)).

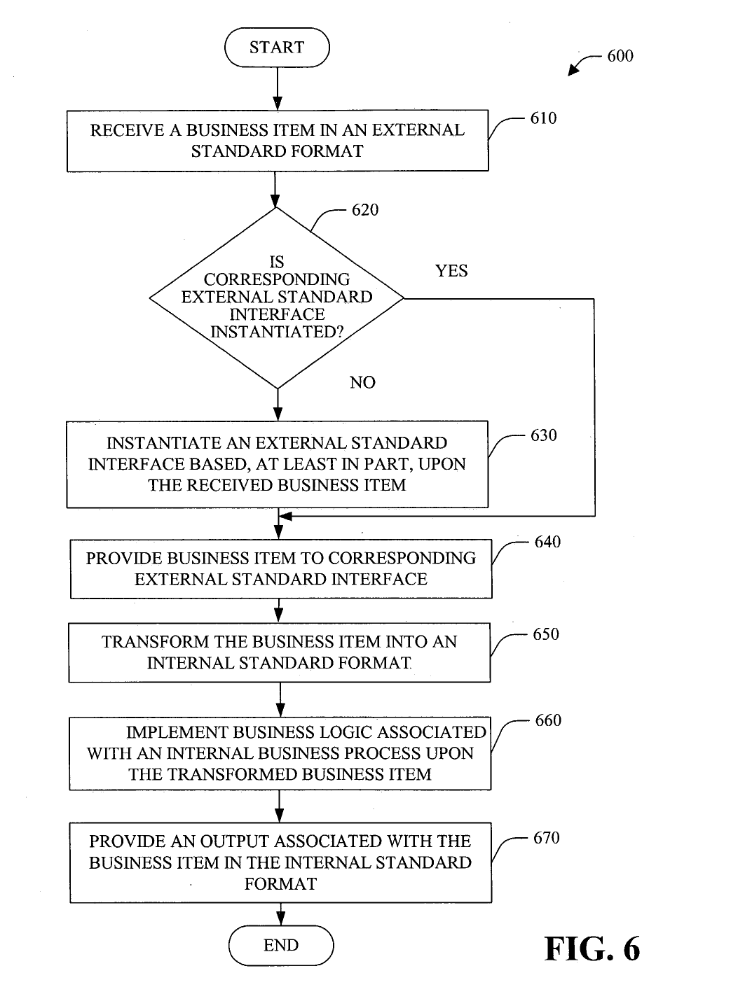

Next, turning to FIG. 6, a method of facilitating e-business 600 in accordance with an aspect of the present invention is illustrated. At 610, a business item in an external standard format is received. At 620, a determination is made as to whether a corresponding external standard interface associated with the external standard format is instantiated. If the determination at 620 is NO, at 630, an external standard interface is instantiated based, at least in part, upon the received business item and processing continues at 640. If the determination at 620 is YES, at 640, the business item is provided to a corresponding external standard interface.

At 650, the business item is transformed into an internal standard format. At 660, business logic associated with internal business process(es) is implemented upon the transformed business item. At 670, an output associated with the business item in the internal standard format is provided (e.g., to internal business application(s)).

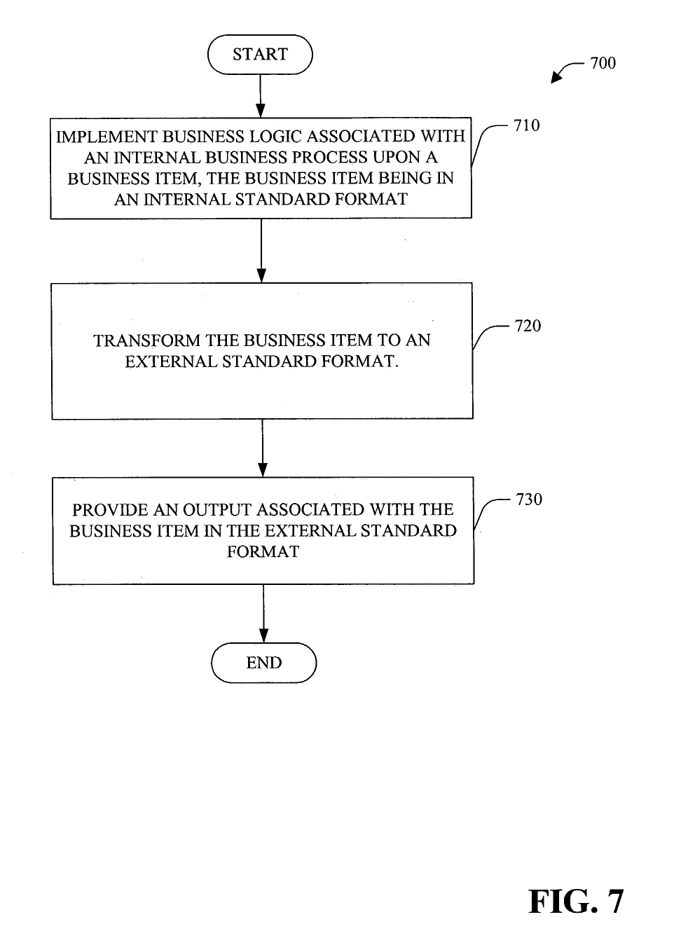

Referring to FIG. 7, a method of facilitating e-business 700 in accordance with an aspect of the present invention is illustrated. At 710, business logic associated with an internal business process is implemented upon a business item, the business item being in an internal standard format. At 720, the business item is transformed into an external standard format. At 730, an output associated with the business item in the external standard format is provided.

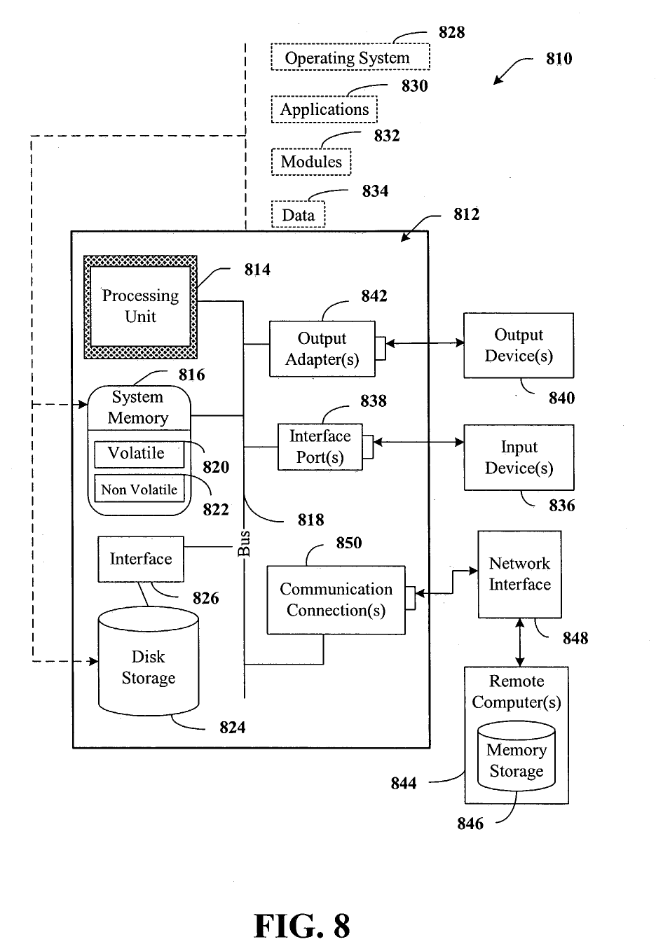

In order to provide additional context for various aspects of the present invention, FIG. 8 and the following discussion are intended to provide a brief, general description of a suitable operating environment 810 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software. Generally, however, program modules include routines, programs, objects, components, data structures, etc. that perform particular tasks or implement particular data types. The operating environment 810 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 8, an exemplary environment 810 for implementing various aspects of the invention includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable ROM (EEPROM), or flash memory. Volatile memory 820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 812 also includes removable/nonremovable, volatile/nonvolatile computer storage media. FIG. 8 illustrates, for example a disk storage 824. Disk storage 824 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in suitable operating environment 810. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that the present invention can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812, and to output information from computer 812 to an output device 840. Output adapter 842 is provided to illustrate that there are some output devices 840 like monitors, speakers, and printers among other output devices 840 that require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An e-business system comprising:
at least one external standard interface that receives a business item in an external standard format and transforms the business item to an internal standard format; and,
an internal standard interface that receives the business item in an internal standard format, implements business logic associated with an internal business process and provides an output based, at least in part, upon the business item in an internal standard format and the implemented business logic.

2. The system of claim 1, the external standard comprising at least one of cXML, RosettaNet, xCBL, EDI 4010, EDI 4020 and SWIFT.

3. The system of claim 1, the business logic comprising a business process rule.

4. The system of claim 1, further comprising an internal business application.

5. The system of claim 1, wherein the business item is received from an external trading partner.

6. The system of claim 1, further comprising a router component that routes the business item to one of a plurality of external standard interfaces based, at least in part, upon the business item.

7. The system of claim 1, further comprising a router component that instantiates one of a plurality of external standard interfaces based, at least in part, upon the business item.

8. An e-business system comprising:
an internal standard interface that receives the business item in an internal standard format, implements business logic associated with an internal business process and provides an output based, at least in part, upon the business item in an internal standard format and the implemented business logic; and,
at least one external standard interface that receives the business item in an internal standard format and transforms the business item to an external standard format.

9. The system of claim 8, the external standard comprising at least one of cXML, RosettaNet, xCBL, EDI 4010, EDI 4020 and SWIFT.

10. The system of claim 8, the business logic comprising a business process rule.

11. The system of claim 8, further comprising an internal business application.

12. The system of claim 8, wherein the business item is received from an external trading partner.

13. An e-business system comprising:
an external standard layer that receives a business item in an external standard format and transforms the business item to an internal standard format; and,
an internal standard layer that receives the business item in an internal standard format, implements business logic associated with an internal business process and provides an output based, at least in part, upon the business item in an internal standard format and the implemented business logic.

14. The system of claim 13, wherein the external standard layer further receives a business item in an internal standard format from the internal standard layer, transforms the business item to an external standard format and provides the transform business item as an output.

15. The system of claim 13, wherein the internal standard layer further receives a business item in an internal standard format, implements business logic associated with an internal business process and provides an output to the external standard layer based, at least in part, upon the business item in an internal standard format and the implemented business logic.

16. The system of claim 13, the external standard layer comprising at least one external standard interface that transforms the business item to an internal standard format.

17. The system of claim 16, the external standard comprising at least one of cXML, RosettaNet, xCBL, EDI 4010, EDI 4020 and SWIFT.

18. The system of claim 13, the internal standard layer comprising an internal standard interface definition that defines an internal business process.

19. A method of facilitating e-business comprising:
transforming a business item in an external standard format into an internal standard format;
implementing business logic associated with an internal business process upon the transformed business item; and,
providing an output associated with the business item in the internal standard format the implemented business logic.

20. The method of claim 19, the external standard format comprising at least one of cXML, RosettaNet, xCBL, EDI 4010, EDI 4020 and SWIFT.

21. A computer readable medium having stored thereon computer executable instructions for carrying out the method of claim 19.

22. The method of claim 19, further comprising instantiating an external standard interface based, at least in part, upon the received business item.

23. A method of facilitating e-business comprising:
implementing business logic associated with an internal business process upon a business item, the business item being in an internal standard format;
transforming the business item to an external standard format.

24. A computer readable medium having stored thereon computer executable instructions for carrying out the method of claim 23.

25. A data packet transmitted between two or more computer components that facilitates e-business, the data packet comprising:
a business input transformed by an external business process interface from an external standard format into an internal standard format.

26. A computer readable medium storing computer executable components of an e-business system comprising:
at least one external standard interface component that receives a business item in an external standard format and transforms the business item to an internal standard format; and,
an internal standard interface component that receives the business item in an internal standard format, implements business logic associated with an internal business process and provides an output based, at least in part, upon the business item in an internal standard format and the implemented business logic.

27. An e-business system comprising:
means for transforming a business item in an external standard format into an internal standard format;
means for implementing business logic associated with an internal business process upon the transformed business item; and,
means for providing an output associated with the business item in the internal standard format the implemented business logic.
